(19) United States
(12) Patent Application Publication
(10) Pub. No.: US 2012/0243440 A1
(43) Pub. Date: Sep. 27, 2012

(54) METHOD FOR FEEDING BACK CHANNEL STATE INFORMATION AND DETERMINING COORDINATED MULTI-POINT MODE AND DEVICE

(75) Inventor: Xingwei Zhang, Beijing (CN)

(73) Assignee: Huawei Technologies Co., Ltd., Shenzhen (CN)

(21) Appl. No.: 13/489,196

(22) Filed: Jun. 5, 2012

Related U.S. Application Data
(63) Continuation of application No. PCT/CN2010/079548, filed on Dec. 8, 2010.

(30) Foreign Application Priority Data
Dec. 31, 2009 (CN) 200910265797.7

(51) Int. Cl. H04W 84/02

(52) U.S. Cl. 370/255

(57) ABSTRACT

A method for feeding back channel state information and determining a coordinated multi-point mode and a device are disclosed. The method for feeding back channel state information includes: obtaining multiple pieces of channel state information of multiple cells in a coordinated multi-point mode; and selecting the preset quantity of pieces of irrelevant channel state information from the multiple pieces of channel state information, and feeding back the selected channel state information to a corresponding network side device.

### CROSS-REFERENCE TO RELATED APPLICATIONS

This application is a continuation of International Application No. PCT/CN2010/079548, filed on Dec. 8, 2010, which claims priority to Chinese Patent Application No. 200910265797.7, filed on Dec. 31, 2009, both of which are hereby incorporated by reference in their entireties.

### FIELD OF THE DISCLOSURE

The present disclosure relates to the field of communications technologies, and in particular, to a method for feeding back channel state information and determining a coordinated multi-point mode and a device.

### BACKGROUND

The LTE (Long Term Evolution, Long Term Evolution) technology is the evolution of the 3G, and improves and enhances the air access technology of the 3G. As a further enhancement of the LTE technology, an LTE-A (LTE-Advance, LTE-Advanced) system imposes a higher bandwidth requirement than an LTE system. In the LTE-A system, a UE (User Equipment, user equipment) needs to feed back channel state information to a network side, so as to enable a network side device eNB (eNodeB, eNodeB) to determine, according to the received channel state information, an MCS (Modulation and Coding Scheme, modulation and coding scheme) used for transmitting downlink data information.

The UE may feed back the channel state information in many manners, including direct feedback of channel state information, indirect feedback of channel state information, and SRS (Sounding Reference Signal, sounding reference signal)-based feedback of channel state information. For the manner of indirect feedback of channel state information in a multi-cell scenario, one form provided by the prior art is that: the UE randomly selects the preset quantity of pieces of channel state information from all channel state information, and then feeds back the selected channel state information to the eNB. A second form is that: the UE sorts all channel state information into types according to the number of cells that serve the UE, randomly selects a piece of channel state information from each type, and then feeds back the selected channel state information to the eNB. Regardless of the form of indirect feedback of channel state information, after receiving the fed back channel state information, the eNB calculates all channel state information according to the fed back channel state information, and selects a coordinated multi-point mode with the best channel state according to all the channel state information.

The method for feeding back channel state information and determining a coordinated multi-point mode in the prior art at least has the following disadvantages:

In both of the two forms of indirect feedback of channel state information provided in the prior art, the randomly-selected channel state information is fed back to the eNB; when a certain combination of channel state information is fed back, the eNB cannot obtain all channel state information through the fed back channel state information. Consequently, the best coordinated multi-point mode determined according to the channel state information by the eNB is inaccurate, which affects quality of communication to be performed next time.

### SUMMARY

In one aspect, a method for feeding back channel state information is provided. The method includes:

obtaining multiple pieces of channel state information of multiple cells in a coordinated multi-point mode, where each piece of channel state information corresponds to one type of coordinated multi-point transmission point configuration; and

selecting the preset quantity of pieces of irrelevant channel state information from the multiple pieces of channel state information, and feeding back the selected channel state information to a network side device.

In another aspect, a method for determining a coordinated multi-point mode is provided. The method includes:

receiving the preset quantity of pieces of irrelevant channel state information fed back by a terminal device, where each piece of channel state information corresponds to one type of coordinated multi-point transmission point configuration;

calculating channel state information corresponding to the other coordinated multi-point transmission point configuration according to the preset quantity of pieces of irrelevant channel state information; and

according to the preset quantity of pieces of irrelevant channel state information and the channel state information that is obtained through calculation, selecting a coordinated multi-point mode with the best channel state.

A terminal device is further provided. The terminal device includes:

an obtaining module, configured to obtain multiple pieces of channel state information of multiple cells in a coordinated multi-point mode, where each piece of channel state information corresponds to one type of coordinated multi-point transmission point configuration; and

a selecting module, configured to select the preset quantity of pieces of irrelevant channel state information from the multiple pieces of channel state information obtained by the obtaining module; and

a feedback module, configured to feed back the channel state information selected by the selecting module to a network side device.

A network side device is further provided. The network side device includes:

a receiving module, configured to receive the preset quantity of pieces of irrelevant channel state information fed back by a terminal device, where each piece of channel state information corresponds to one type of coordinated multi-point transmission point configuration;

a calculating module, configured to calculate channel state information corresponding to the other coordinated multi-point transmission point configuration according to the preset quantity of pieces of irrelevant channel state information received by the receiving module; and

a selecting module, configured to: according to the preset quantity of pieces of irrelevant channel state information and the channel state information that is obtained through calculation by the calculating module, select a coordinated multi-point mode with the best channel state.

### BRIEF DESCRIPTION OF THE DRAWINGS

To make the technical solutions in the embodiments of the present invention or in the prior art clearer, accompanying drawings involved in the description of the embodiments or the prior art are briefly introduced below. Apparently, the accompanying drawings in the following description are merely about some embodiments of the present invention, and persons of ordinary skill in the art may further obtain other drawings according to these accompanying drawings without making creative efforts.

FIG. 1 is a flowchart of a method for feeding back channel state information according to a first embodiment of the present invention;

FIG. 2 is a flowchart of a method for feeding back channel state information according to a second embodiment of the present invention;

FIG. 3 is a schematic diagram of a network structure according to the second embodiment of the present invention;

FIG. 4 is a schematic diagram of a first form of feeding back channel state information according to the second embodiment of the present invention;

FIG. 5 is a schematic diagram of a second form of feeding back channel state information according to the second embodiment of the present invention;

FIG. 6 is a schematic diagram of a third form of feeding back channel state information according to the second embodiment of the present invention;

FIG. 7 is a flowchart of a method for determining a coordinated multi-point mode according to a third embodiment of the present invention;

FIG. 8 is a flowchart of a method for determining a coordinated multi-point mode according to a fourth embodiment of the present invention;

FIG. 9 is a flowchart of a communication method according to a fifth embodiment of the present invention;

FIG. 10 is a schematic structural diagram of a communication system according to a sixth embodiment of the present invention;

FIG. 11 is a schematic structural diagram of a terminal device according to a seventh embodiment of the present invention;

FIG. 12 is a schematic structural diagram of a first type of selecting module in the terminal device according to the seventh embodiment of the present invention;

FIG. 13 is a schematic structural diagram of a second type of selecting module in the terminal device according to the seventh embodiment of the present invention;

FIG. 14 is a schematic structural diagram of a third type of selecting module in the terminal device according to the seventh embodiment of the present invention;

FIG. 15 is a schematic structural diagram of a fourth type of selecting module in the terminal device according to the seventh embodiment of the present invention; and

FIG. 16 is a schematic structural diagram of a network side device according to an eighth embodiment of the present invention.

### DETAILED DESCRIPTION OF THE EMBODIMENTS

To make the objectives, technical solutions, and benefits of the present invention clearer, the following further describes the embodiments of the present invention in detail with reference to the accompanying drawings.

### Embodiment 1

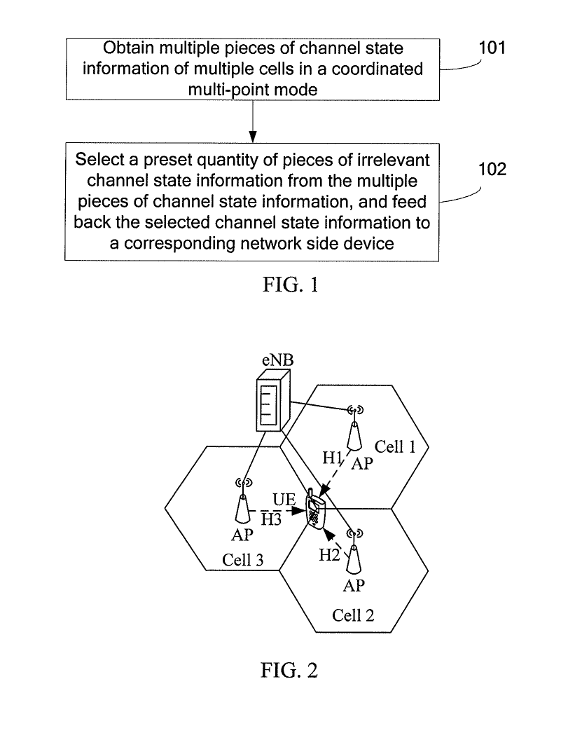

Referring to FIG. 1, this embodiment provides a method for feeding back channel state information. A specific process is as follows:

101: Obtain multiple pieces of channel state information of multiple cells in a coordinated multi-point mode.

102: Select the preset quantity of pieces of irrelevant channel state information from the multiple pieces of channel state information, and feed back the selected channel state information to a corresponding network side device.

The preset quantity may be set according to an actual condition. For example, the preset quantity is set by using the principle of minimizing feedback overhead of multiple pieces of channel state information, or the preset quantity is set according to a coordinated multi-point requirement imposed by the corresponding network side device. This embodiment does not limit the specific preset quantity.

In the method provided in this embodiment, the terminal device selects the preset quantity of pieces of irrelevant channel state information from multiple pieces of channel state information, and feeds back the irrelevant channel state information to the corresponding network side device, so that the network side device can calculate other channel state information according to the received channel state information, and further select the coordinated multi-point mode with the best channel state from more channel state information, thereby ensuring quality of transmitting downlink data information.

### Embodiment 2

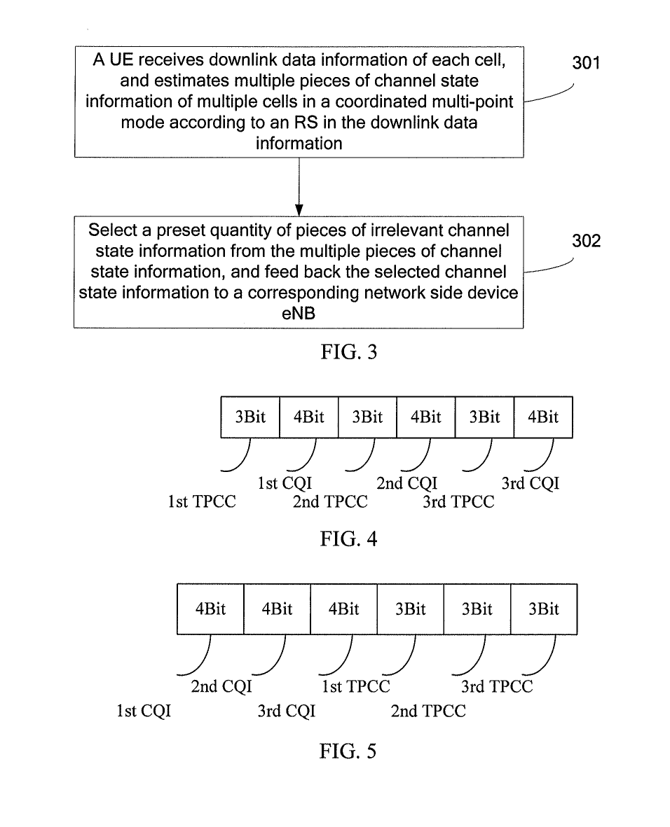

This embodiment provides a method for feeding back channel state information. In this method, irrelevant channel state information is fed back to a corresponding network side device through a manner of excluding feedback of relevant channel state information, so that the network side device can obtain other channel state information according to the fed back channel state information, so as to provide reference for the network side device to select a best coordinated multi-point mode. For ease of description, this embodiment takes a 3-cell CoMP (Coordinated Multi-Point, coordinated multi-point) JP (Joint Processing, joint processing) network structure shown in FIG. 2 as an example. That is, it takes an example that 3 transmission points transmit data to a UE, to describe the method provided in this embodiment in detail. Referring to FIG. 3, a process of the method is specifically as follows:

301: A UE receives downlink data information of each cell, and estimates multiple pieces of channel state information of multiple cells in a coordinated multi-point mode according to an RS (Reference Signal, reference signal) in the downlink data information.

The downlink data information is sent by a network side device eNB. All channel state information refers to channel state information between UEs in all coordinating cells and all coordinating eNBs or APs (Access Point, access points). There may be multiple forms of the fed back channel state information, and this embodiment does not limit the specific form of the fed back channel state information, which may be, for example, an SINR (Signal-to-Interference and Noise Ratio, signal-to-interference and noise ratio), or CQI (Channel Quality Information, channel quality information) into which the SINR is quantized and converted. Channel state information fed back through an existing protocol is CQI, which is divided into 15 levels in total and expressed by 4 bits. This embodiment does not limit the correspondence between the SINR and the CQI. Reference may be made to Table 1:

TABLE 1

| CQI | SINR Range (dB) |
|---|---|
| 0 | reserved |
| 1 | (−∞, −5.108) |
| 2 | [−5.108, −3.216) |
| 3 | [−3.216, −1.324) |
| 4 | [−1.324, 0.568) |
| 5 | [0.568, 2.46) |
| 6 | [2.46, 4.352) |
| 7 | [4.352, 6.244) |
| 8 | [6.244, 8.136) |
| 9 | [8.136, 10.028) |
| 10 | [10.028, 11.92) |
| 11 | [11.92, 13.812) |
| 12 | [13.812, 15.704) |
| 13 | [15.704, 17.596) |
| 14 | [17.596, 9.488) |
| 15 | [9.488, ∞) |

This embodiment merely takes an example that the fed back channel state information is SINR to describe the method for feeding back channel state information provided in this embodiment.

First, according to different TPCCs (Transmission Points Configuration for CoMP, transmission points configuration for CoMP), the following 7 types of conditions for the CoMP are shown in Table 2:

TABLE 2

| TPCC Index | CoMP Transmission Point |
|---|---|
| 1 | Cell 1 |
| 2 | Cell 2 |
| 3 | Cell 3 |
| 4 | Cell 1, cell 2 |
| 5 | Cell 1, cell 3 |
| 6 | Cell 2, cell 3 |
| 7 | Cell 1, cell 2, cell 3 |

In Table 2, SINR expressions corresponding to the 7 types of TPCCs are:

$$\begin{matrix}TPCC 1 \text{:} {SINR}_{1} = \frac{{‖ {H}_{11} {w}_{1} ‖}_{2}^{2} {P}_{1}}{{‖ {H}_{21} {w}_{2} ‖}_{2}^{2} {P}_{2} + {‖ {H}_{31} {w}_{3} ‖}_{2}^{2} {P}_{3} + {N}_{0} + {I}_{0}} = a & ( 1 ) \\ TPCC 2 \text{:} {SINR}_{2} = \frac{{‖ {H}_{21} {w}_{2} ‖}_{2}^{2} {P}_{2}}{{‖ {H}_{11} {w}_{1} ‖}_{2}^{2} {P}_{1} + {‖ {H}_{31} {w}_{3} ‖}_{2}^{2} {P}_{3} + {N}_{0} + {I}_{0}} = b & ( 2 ) \\ TPCC 3 \text{:} {SINR}_{3} = \frac{{‖ {H}_{31} {w}_{3} ‖}_{2}^{2} {P}_{3}}{{‖ {H}_{11} {w}_{1} ‖}_{2}^{2} {P}_{1} + {‖ {H}_{21} {w}_{2} ‖}_{2}^{2} {P}_{2} + {N}_{0} + {I}_{0}} = c & ( 3 ) \\ TPCC 4 \text{:} {SINR}_{1 , 2}^{H} = \frac{{{‖ }_{11} {w}_{1} ‖}_{2}^{2} {P}_{1} + {‖ {H}_{21} {w}_{2} ‖}_{2}^{2} {P}_{2}}{{‖ {H}_{31} {w}_{3} ‖}_{2}^{2} {P}_{3} + {N}_{0} + {I}_{0}} = d & ( 4 ) \\ TPCC 5 \text{:} {SINR}_{1 , 3} = \frac{{‖ {H}_{11} {w}_{1} ‖}_{2}^{2} {P}_{1} + {‖ {H}_{31} {w}_{3} ‖}_{2}^{2} {P}_{3}}{{‖ {H}_{21} {w}_{2} ‖}_{2}^{2} {P}_{2} + {N}_{0} + {I}_{0}} = e & ( 5 ) \\ TPCC 6 \text{:} {SINR}_{2 , 3} = \frac{{‖ {H}_{21} {w}_{2} ‖}_{2}^{2} {P}_{2} + {‖ {H}_{31} {w}_{3} ‖}_{2}^{2} {P}_{3}}{{‖ {H}_{11} {w}_{1} ‖}_{2}^{2} {P}_{1} + {N}_{0} + {I}_{0}} = f & ( 6 ) \\ TPCC 7 \text{:} {SINR}_{1 , 2 , 3} = \frac{{‖ {H}_{11} {w}_{1} ‖}_{2}^{2} {P}_{1} + {‖ {H}_{21} {w}_{2} ‖}_{2}^{2} {P}_{2} + {‖ {H}_{31} {w}_{3} ‖}_{2}^{2} {P}_{3}}{{N}_{0} + {I}_{0}} = g & ( 7 )\end{matrix}$$

Pᵢ is transmit power of a network side of a cell i; Hᵢⱼ is a channel matrix between the cell i and a UEⱼ (in this embodiment, an example that a UE shown in FIG. 2 is a UE1 is taken), Wᵢ is a precoding matrix, N₀ is white noise, and I₀ is interference from other UEs or other cells except cells 1, 2, and 3. The SINR expressions corresponding to the foregoing 7 types of TPCCs may be obtained through the prior art, and details are not repeated here.

302: Select the preset quantity of pieces of irrelevant channel state information from the multiple pieces of channel state information, and feed back the selected channel state information to a corresponding network side device eNB.

In this step, the multiple pieces of channel state information may be all channel state information of multiple cells in a coordinated multi-point mode, and may also be part of the channel state information, which is not specifically limited in the embodiment. The preset quantity may be set according to an actual condition. For example, the preset quantity is set by using the principle of minimizing feedback overhead of multiple pieces of channel state information, or the preset quantity is set according to a coordinated multi-point requirement imposed by the corresponding network side device. This embodiment does not limit the specific preset quantity.

Taking an example that the preset quantity is 3, if the selected channel state information is SINRs corresponding to TPCC 1, 2, 4 {cell 1, cell 2, cells 1 and 2}, that is, channel state information a, b, and d are selected, where the channel state information a is that the cell 1 serves the UE separately, the channel state information b is that the cell 2 serves the UE separately, and the channel state information c is that the cells 1 and 2 serve the UE jointly, which is shown in the following equation set (8):

$$\begin{matrix}\{ \begin{matrix}{SINR}_{1} = \frac{{‖ {H}_{11} {w}_{1} ‖}_{2}^{2} {P}_{1}}{{‖ {H}_{21} {w}_{2} ‖}_{2}^{2} {P}_{2} + {‖ {H}_{31} {w}_{3} ‖}_{2}^{2} {P}_{3} + {N}_{0} + {I}_{0}} = a \\ {SINR}_{2} = \frac{{‖ {H}_{21} {w}_{2} ‖}_{□}^{2} {P}_{2}}{{‖ {H}_{11} {w}_{1} ‖}_{2}^{2} {P}_{1} + {‖ {H}_{31} {w}_{3} ‖}_{2}^{2} {P}_{3} + {N}_{0} + {I}_{0}} = b \\ {SINR}_{1 , 2}^{H} = \frac{{{‖ }_{11} {w}_{1} ‖}_{2}^{2} {P}_{1} + {‖ {H}_{21} {w}_{2} ‖}_{2}^{2} {P}_{2}}{{‖ {H}_{31} {w}_{3} ‖}_{2}^{2} {P}_{3} + {N}_{0} + {I}_{0}} = d\end{matrix} & ( 8 ) \\ Let \{ \begin{matrix}\frac{{‖ {H}_{11} {w}_{1} ‖}_{2}^{2} {P}_{1}}{{N}_{0} + {I}_{0}} = x \\ \frac{{‖ {H}_{21} {w}_{2} ‖}_{2}^{2} {P}_{2}}{{N}_{0} + {I}_{0}} = y \\ \frac{{‖ {H}_{31} {w}_{3} ‖}_{2}^{2} {P}_{3}}{{N}_{0} + {I}_{0}} + 1 = z\end{matrix} & ( 9 )\end{matrix}$$

Then, the equation set (8) may be converted into:

$$\{ \begin{matrix}\frac{x}{y + z} = a \\ \frac{y}{x + z} = b \\ \frac{x + y}{z} = d\end{matrix} \{ \begin{matrix}x - ay - az = 0 \\ bx - y + bz = 0 \\ x + y - dz = 0\end{matrix} \\ ( \begin{matrix}1 & - a & - a \\ b & - 1 & b \\ 1 & 1 & - d\end{matrix} ) ( \begin{matrix}x \\ y \\ z\end{matrix} ) = 0 \\ \vec{A} \vec{X} = \vec{B} = 0 ⇒ X = 0 \\ ⇒ \{ \begin{matrix}x = 0 \\ y = 0 \\ z = 0\end{matrix}$$

It may be seen that, this equation set has no constant, and only zero solutions can be obtained. Therefore, it may be deduced that the SINRs corresponding to TPCC 1, 2, 4 {cell 1, cell 2, cells 1 and 2} are relevant. If the 3 SINRs are fed back to the corresponding network side device, the corresponding network side device cannot obtain SINRs corresponding to all the 7 types of TPCCs. It is the same with SINRs corresponding to TPCC 1, 3, 5 {cell 1, cell 3, cells 1 and 3} and SINRs corresponding to TPCC 2, 3, 6 {cell 2, cell 3, cells 2 and 3}. The SINRs corresponding to such combinations are also relevant.

There is another case in which relevance is formed. Taking an example that the SINRs corresponding to TPCC 3, 4, 7 {cell 3, cells 1 and 2, cells 1, 2 and 3} are selected, that is, channel state information c, d, and g are selected, where the channel state information c is that the cell 1 serves the UE separately, the channel state information d is that the cells 1 and 2 serve the UE jointly, and the channel state information g is that the cells 1, 2 and 3 serve the UE jointly, which is as shown in the following equation set (10):

$$\begin{matrix}\{ \begin{matrix}{SINR}_{3} = \frac{{‖ {H}_{31} {w}_{3} ‖}_{2}^{2} {P}_{3}}{{‖ {H}_{11} {w}_{1} ‖}_{2}^{2} {P}_{1} + {‖ {H}_{21} {w}_{2} ‖}_{2}^{2} {P}_{2} + {N}_{0} + {I}_{0}} = c \\ {SINR}_{1 , 2}^{H} = \frac{{{‖}_{11} {w}_{1} ‖}_{2}^{2} {P}_{1} + {‖ {H}_{21} {w}_{2} ‖}_{2}^{2} {P}_{2}}{{‖ {H}_{31} {w}_{3} ‖}_{2}^{2} {P}_{3} + {N}_{0} + {I}_{0}} = d \\ {SINR}_{1 , 2 , 3} = \frac{{‖ {H}_{11} {w}_{1} ‖}_{2}^{2} {P}_{1} + {‖ {H}_{21} {w}_{2} ‖}_{2}^{2} {P}_{2} + {‖ {H}_{31} {w}_{3} ‖}_{2}^{2} {P}_{3}}{{N}_{0} + {I}_{0}} = g\end{matrix} & ( 10 ) \\ Let \{ \begin{matrix}\frac{{‖ {H}_{11} {w}_{1} ‖}_{2}^{2} {P}_{1}}{{N}_{0} + {I}_{0}} = x \\ \frac{{‖ {H}_{21} {w}_{2} ‖}_{2}^{2} {P}_{2}}{{N}_{0} + {I}_{0}} = y \\ \frac{{‖ {H}_{31} {w}_{3} ‖}_{2}^{2} {P}_{3}}{{N}_{0} + {I}_{0}} = z\end{matrix} & ( 11 )\end{matrix}$$

Then, the equation set (10) may be converted into:

$$\{ \begin{matrix}\frac{x + y}{z + 1} = d \\ \frac{z}{x + y + 1} = c \\ \frac{x + y + z}{1} = g\end{matrix}$$

It may be seen that, x and y in the equation set always exist in the form of (x+y). Only (x+y) and z can be calculated out of the equation set, and x and y cannot be calculated separately. Therefore, it may be deduced that the SINRs corresponding to TPCC 3, 4, 7 {cell 3, cells 1 and 2, cells 1, 2 and 3} are relevant. If the SINRs corresponding to the 3 TPCCs are fed back to the network side device, the network side device cannot obtain channel state information corresponding to all 7 types of TPCCs. Relevant channel state information combinations which are the same as that in this case include: TPCC 1, 6, 7 {cell 1, cells 2 and 3, cells 1, 2 and 3} and TPCC 2, 5, 7 {cell 2, cells 1 and 3, cells 1, 2, and 3}.

Through the foregoing analysis, the channel state information fed back in this step is not channel state information corresponding to three TPCCs selected randomly. Combinations with relevance need to be excluded. The combinations with relevance include the following types:

TPCC 1, 2, 4 {cell 1, cell 2, cells 1 and 2}; TPCC 1, 3, 5 {cell 1, cell 3, cells 1 and 3}; TPCC 2, 3, 6 {cell 2, cell 3, cells 2 and 3};

TPCC 1, 6, 7 {cell 1, cells 2 and 3, cells 1, 2 and 3}; TPCC 2, 5, 7 {cell 2, cells 1 and 3, cells 1, 2 and 3}; and TPCC 3, 4, 7 {cell 3, cells 1 and 2, cells 1, 2 and 3}.

C₇³−6=29 types of remaining irrelevant combinations exist.

Specifically, the selecting the preset quantity of pieces of irrelevant channel state information from all channel state information includes, but is not limited to, the following selection manners:

a. Select the preset quantity of pieces of channel state information from multiple pieces of channel state information, and determine whether the preset quantity of pieces of the selected channel state information are relevant; if they are relevant, continue the selecting until the preset quantity of pieces of irrelevant channel state information are selected out.

For example, select 3 SINRs randomly from the SINRs corresponding to 7 types of TPCCs. Determine whet her the selected 3 SINRs are relevant. If they are relevant, continue the selecting until 3 irrelevant SINRs are selected.

b. Group multiple pieces of channel state information according to the preset quantity to obtain multiple combinations each of which includes the preset quantity of pieces of channel state information. Determine irrelevant combinations from the multiple combinations each of which includes the preset quantity of pieces of channel state information, and select a combination of channel state information from the determined irrelevant combinations.

For example, there are C₇³=35 results for randomly selecting SINRs corresponding to three types of TPCCs from the SINRs corresponding to the 7 types of TPCCs. The 35 results are divided into two types: relevant combinations (6 combinations in total) and irrelevant combinations (29 combinations in total). Select a combination of SINRs from the 29 irrelevant combinations.

c. Sort the multiple pieces of channel state information into types according to the number of cells that provide services. Select a piece of channel state information in each type to obtain the preset quantity of pieces of channel state information. Determine whether the preset quantity of pieces of the obtained channel state information are relevant; if they are relevant, continue the selecting until the preset quantity of pieces of irrelevant channel state information are selected out.

For example, sort the 7 types of TPCCs into the following 3 types according to the number of cells that provide service:

Type 1: A single cell serves the UE: TPCC1 (cell 1), TPCC2 (cell 2), TPCC3 (cell 3).

Type 2: Two cells serve the UE: TPCC4 (cell 1 and cell 2), TPCC5 (cell 1 and cell 3), and TPCC6 (cell 2 and cell 3).

Type 3: All the three cells serve the UE: TPCC7 (cell 1, cell 2, and cell 3).

Accordingly, sort the SINRs corresponding to the TPCCs according to the number of cells that provide services. The types after sorting is the same as that in the sorting of the TPCCs. Randomly select an SINR in each type. 3 SINRs are obtained due to 3 cells. Determine whether the 3 obtained SINRs are relevant; if they are relevant, continue the selecting until 3 irrelevant SINRs are selected.

d. Sort the multiple pieces of channel state information into types according to the number of cells that provide services. Select a piece of channel state information from each type each time to obtain multiple combinations, where each of the multiple combinations includes the preset quantity of pieces of channel state information. Determine irrelevant combinations from the multiple combinations each of which includes the preset quantity of pieces of channel state information; and select a combination of channel state information from the irrelevant combinations.

For example, sort the 7 types of TPCCs into types according to the number of cells that provide services (a sorting result is the same as that in the manner c); randomly select an SINR corresponding to a TPCC in each type (in type 3, only channel state information corresponding to TPCC 7 may be selected) to obtain the SINRs corresponding to 3 TPCCs. According to a multiplication principle, there are 3×3×1=9 possible combinations of selecting an SINR corresponding to a TPCC in each type. Determine relevant combinations (3 combinations in total) in the 9 possible combinations:

TPCC 1, 6, 7 {cell 1, cells 2 and 3, cells 1, 2 and 3}; TPCC 2, 5, 7 {cell 2, cells 1 and 3, cells 1, 2 and 3}; and TPCC 3, 4, 7 {cell 3, cells 1 and 2, cells 1, 2 and 3}.

Therefore, the following 6 combinations of irrelevant channel state information remain:

TPCC 1, 4, 7 {cell 1, cells 1 and 2; cells 1, 2 and 3}; TPCC 1, 5, 7 {cell 1, cells 1 and 3, cells 1, 2 and 3}; and TPCC 2, 4, 7 {cell 2, cells 1 and 2, cells 1, 2 and 3}.

TPCC 2, 6, 7 {cell 2, cells 2 and 3, cells 1, 2 and 3}; TPCC 3, 5, 7 {cell 3, cells 1 and 3, cells 1, 2 and 3}; and TPCC 3, 6, 7 {cell 3, cells 2 and 3, cells 1, 2 and 3}.

Then, randomly select a combination of SINRs from the 6 irrelevant combinations.

It should be noted that, as regards the foregoing four manners a, b, c, and d for selecting the preset quantity of pieces of irrelevant channel state information, regardless of the selection mode, this embodiment does not limit a specific basis when determining whether the preset quantity of pieces of channel state information are relevant, or determining whether the combinations each of which includes the preset quantity of the pieces of channel state information are relevant is involved, and the determining may be implemented through a manner of presetting a list in a practical application. For example, a list of combinations each of which includes the preset quantity of the pieces of relevant channel state information is preset. After selecting the preset quantity of pieces of channel state information, the UE may compare the selected channel state information with the list. If the selected channel state information is the same as that in the list, the UE determines that the selected channel state information is relevant, and the selection needs to be continued; if the selected channel state information is different from that in the list, the UE determines that the selected channel state information is irrelevant. Similarly, a list of combinations, which include the preset quantity of pieces of irrelevant channel state information may also be preset. This embodiment does not limit whether to preset a relevant list or an irrelevant list.

After the preset quantity of pieces of irrelevant channel state information are selected from the multiple pieces of channel state information, the preset quantity of pieces of the selected irrelevant channel state information and a number of the corresponding coordinated multi-point mode may be fed back together to the corresponding network side device when the selected channel state information is fed back to the corresponding network side device. For example, if the selected channel state information is channel state information corresponding to TPCC 1, 5, 7 (cell 1, cells 1 and 3, cells 1, 2 and 3), not only the channel state information corresponding to TPCC 1, 5, 7 {cell 1, cells 1 and 3, cells 1, 2 and 3} needs to be fed back to the corresponding network side device, but also their respective corresponding numbers TPCC 1, 5, 7 need to be fed back together to the corresponding network side device. This embodiment does not limit the specific form of a TPCC number. Reference may be made to the following Table 3:

TABLE 3

| TPCC Number | TPCC Corresponding to the TPCC |
|---|---|
| 000 | TPCC1 |
| 001 | TPCC2 |
| 010 | TPCC3 |
| 011 | TPCC4 |
| 100 | TPCC5 |
| 101 | TPCC6 |
| 110 | TPCC7 |

A specific bitmap may have 4 forms, which are not specifically limited in this embodiment. As shown in FIG. 4, taking an example of reporting a TPCC code and the CQI corresponding to the TPCC, each time a 3-bit TPCC index may be reported first and then a 4-bit CQI index may be reported; or each time, a 4-bit CQI index may be reported first and then a 3-bit TPCC index is reported; or the CQI and the TPCC are reported separately. As shown in FIG. 5, CQIs corresponding to all TPCCs are reported first, and then all the TPCCs are reported; or all TPCCs may also be reported first, and then all corresponding CQIs are reported.

Optionally, in order to reduce complexity for a terminal device to feed back the channel state information, a feedback manner pre-appointed between the network side device and the terminal device may also be adopted, and only a certain irrelevant combination is fed back fixedly. For example, TPCC 1, 4, 7 {cell 1, cells 1 and 2, cells 1, 2 and 3} are fed back fixedly. In this case, the terminal device does not need to reselect feedback content, and implementation is simpler.

Optionally, in order to reduce air interface resources occupied when the terminal device feeds back the channel state information, a manner that the preset quantity of pieces of the selected irrelevant channel state information are fed back to the corresponding network side device according to a preset order may also be adopted. For example, still taking an example that 3 pieces of irrelevant channel state information are selected, and according to the foregoing analysis, there are a total of 29 combinations of selecting 3 pieces of irrelevant channel state information. If coding is performed on the 29 irrelevant combinations, it is as shown in Table 4:

TABLE 4

| Combination | |
|---|---|
| Code | Coordinated Multi-point Mode Corresponding to the Code |
| 00000 | TPCC 1, 2, 3 (cell 1, cell 2, cell 3) |
| 00001 | TPCC 1, 2, 5 (cell 1, cell 2, cells 1 and 3) |
| 00010 | TPCC 1, 2, 6 (cell 1, cell 2, cells 2 and 3) |
| 00011 | TPCC 1, 2, 7 (cell 1, cell 2, cells 1, 2 and 3) |
| 00100 | TPCC 1, 3, 4 (cell 1, cell 3, cells 1 and 2) |
| 00101 | TPCC 1, 3, 6 (cell 1, cell 3, cells 2 and 3) |
| 00110 | TPCC 1, 3, 7 (cell 1, cell 3, cells 1, 2 and 3) |
| 00111 | TPCC 1, 4, 5 (cell 1, cells 1 and 2, cells 1 and 3) |
| 01000 | TPCC 1, 4, 6 (cell 1, cells 1 and 2, cells 1 and 3) |
| 01001 | TPCC 1, 4, 7 (cell 1, cells 1 and 2, cells 1, 2 and 3) |
| 01010 | TPCC 1, 5, 6 (cell 1, cells 1 and 3, cells 2 and 3) |
| 01011 | TPCC 1, 5, 7 (cell 1, cells 1 and 3, cells 1, 2 and 3) |
| 01100 | TPCC 2, 3, 4 (cell 2, cell 3, cells 1 and 2) |
| 01101 | TPCC 2, 3, 5 (cell 2, cell 3, cells 1 and 3) |
| 01110 | TPCC 2, 3, 7 (cell 2, cell 3, cells 1, 2 and 3) |
| 01111 | TPCC 2, 4, 5 (cell 2, cells 1 and 2, cells 1 and 3) |
| 10000 | TPCC 2, 4, 6 (cell 2, cells 1 and 2, cells 2 and 3) |
| 10001 | TPCC 2, 4, 7 (cell 2, cells 1 and 2, cells 1, 2 and 3) |
| 10010 | TPCC 2, 5, 6 (cell 2, cells 1 and 3, cells 2 and 3) |
| 10011 | TPCC 2, 6, 7 (cell 2, cells 2 and 3, cells 1, 2 and 3) |
| 10100 | TPCC 3, 4, 5 (cell 3, cells 1 and 2, cells 1 and 3) |
| 10101 | TPCC 3, 4, 6 (cell 3, cells 1 and 2, cells 2 and 3) |
| 10110 | TPCC 3, 5, 6 (cell 3, cells 1 and 3, cells 2 and 3) |
| 10111 | TPCC 3, 5, 7 (cell 3, cells 1 and 3, cells 1, 2 and 3) |
| 11000 | TPCC 3, 6, 7 (cell 3, cells 2 and 3, cells 1, 2 and 3) |
| 11001 | TPCC 4, 5, 6 (cells 1 and 2, cells 1 and 3, cells 2 and 3) |
| 11010 | TPCC 4, 5, 7 (cells 1 and 2, cells 1 and 3, cells 1, 2 and 3) |
| 11011 | TPCC 4, 6, 7 (cells 1 and 2, cells 2 and 3, cells 1, 2 and 3) |
| 11100 | TPCC 5, 6, 7 (cells 1 and 3, cells 2 and 3, cells 1, 2 and 3) |

As shown in Table 4, when the preset quantity of pieces of the selected irrelevant channel state information are fed back according to the preset order, if 3 pieces of irrelevant channel state information selected by the terminal device is channel state information corresponding to TPCC 3, 4, 6 (cell 3, cells 1 and 2, cells 2 and 3), the terminal device needs to feed back the corresponding code 10101 to the network side device, and pre-acquires a coordinated multi-point mode corresponding to each code through a network side, so that the network side device can acquire a coordinated multi-point mode combination corresponding to the received channel state information according to the received code. The terminal device feeds back channel state information of TPCC 3, 4, 6 according to the preset order. The terminal device and the network side device need to preset a reporting order. Otherwise, the network side device cannot acquire whether the reporting order is TPCC 3, 4, 6 or TPCC 4, 3, 6, or other orders. This feedback manner does not need to feed back 3-bit TPCC number of every of the 3 TPCCs, and this manner of feeding back the channel state information may occupy a few air interface resources. How the network side device pre-acquires the coordinated multi-point mode corresponding to each code may be implemented by pre-storing a list as shown in Table 4 in the network side device. This embodiment does not limit how the network side device pre-acquires the coordinated multi-point mode corresponding to each code, and also does not limit a coding manner, as long as it is ensured that different codes correspond to different coordinated multi-point modes, and the network side device can identify the corresponding coordinated multi-point mode according to a code.

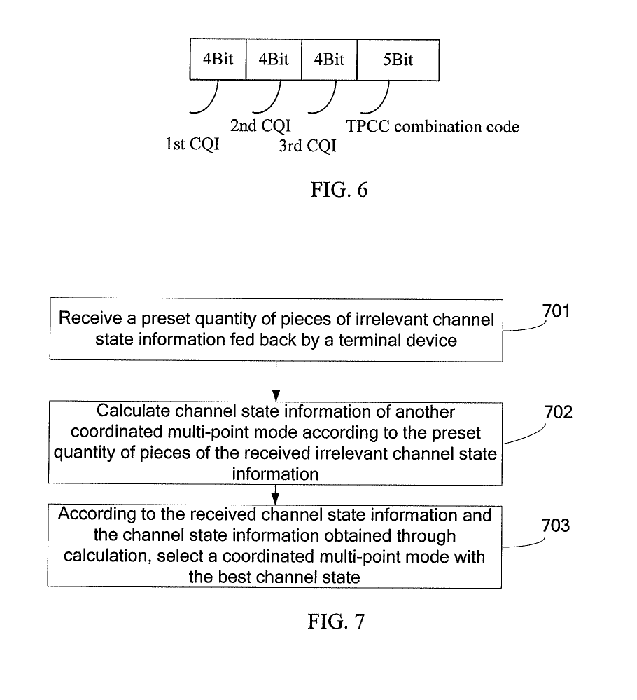

A specific bitmap may have 2 forms, and this embodiment does not specifically limit thereto. Still taking an example of reporting the TPCC combination code and the corresponding CQI, a 5-bit combination code may be reported first, and then every 3-bit CQI is reported according to a preset order; or every 3-bit CQI is reported according to a preset order, and then a 5-bit combination code is reported. The latter manner is taken as an example in this embodiment, as shown in FIG. 6.

In the case that the channel state information is sorted into types, 6 irrelevant combinations may exist through the foregoing analysis when the preset quantity of pieces of irrelevant channel state information are selected by type, and after coding is performed on the 6 irrelevant combinations, it is as shown in Table 5:

TABLE 5

| Combination | |
|---|---|
| Code | Coordinated Multi-point Mode Corresponding to the Code |
| 000 | TPCC 1, 4, 7 (cell 1, cells 1 and 2, cells 1, 2 and 3) |
| 001 | TPCC 1, 5, 7 (cell 1, cells 1 and 3, cells 1, 2 and 3) |
| 010 | TPCC 2, 4, 7 (cell 2, cells 1 and 2, cells 1, 2 and 3) |
| 011 | TPCC 2, 6, 7 (cell 2, cells 2 and 3, cells 1, 2 and 3) |
| 100 | TPCC 3, 5, 7 (cell 3, cells 1 and 3, cells 1, 2 and 3) |
| 101 | TPCC 3, 6, 7 (cell 3, cells 2 and 3, cells 1, 2 and 3) |

Similarly, the terminal device may also feed back the preset quantity of pieces of the selected irrelevant channel state information to the corresponding network side device according to a fixed order. Specific steps are not repeatedly described here.

Besides, in this embodiment, the scenario of jointly processing for 3 cells in a coordinated multi-point mode is only taken as an example to describe the feedback of channel state information provided in this embodiment. Similarly, for cases of jointly processing of 2 cells, or of 4 or more cells in a coordinated multipoint mode, the method provided in this embodiment is also applicable, and details are not repeatedly described here.

In summary, with the method provided in this embodiment, the preset quantity of pieces of irrelevant channel state information are selected from the multiple pieces of channel state information, and the irrelevant channel state information is fed back to the corresponding network side device, so that the network side device can calculate the other channel state information according to the received channel state information, and further select the coordinated multi-point mode with the best channel state from more channel state information, thereby ensuring quality of transmitting downlink data information.

### Embodiment 3

Referring to FIG. 7, this embodiment provides a method for determining a coordinated multi-point mode. A process of the method is specifically as follows:

701: Receive the preset quantity of pieces of irrelevant channel state information fed back by a terminal device.

702: Calculate channel state information of another coordinated multi-point mode according to the preset quantity of pieces of the received irrelevant channel state information.

703: According to the received channel state information and the channel state information that is obtained through calculation, select a coordinated multi-point mode with the best channel state.

The preset quantity of the channel state information fed back by the terminal device may be set according to an actual condition. For example, the preset quantity is set by using the principle of minimizing feedback overhead of multiple pieces of channel state information, or the preset quantity is set according to a coordinated multi-point requirement imposed by a corresponding network side device. This embodiment does not limit the specific preset quantity.

With the method provided in this embodiment, the other channel state information is calculated according to the preset quantity of pieces of the received irrelevant channel state information, so that a best coordinated multi-point mode may be selected, thereby ensuring communication quality.

### Embodiment 4

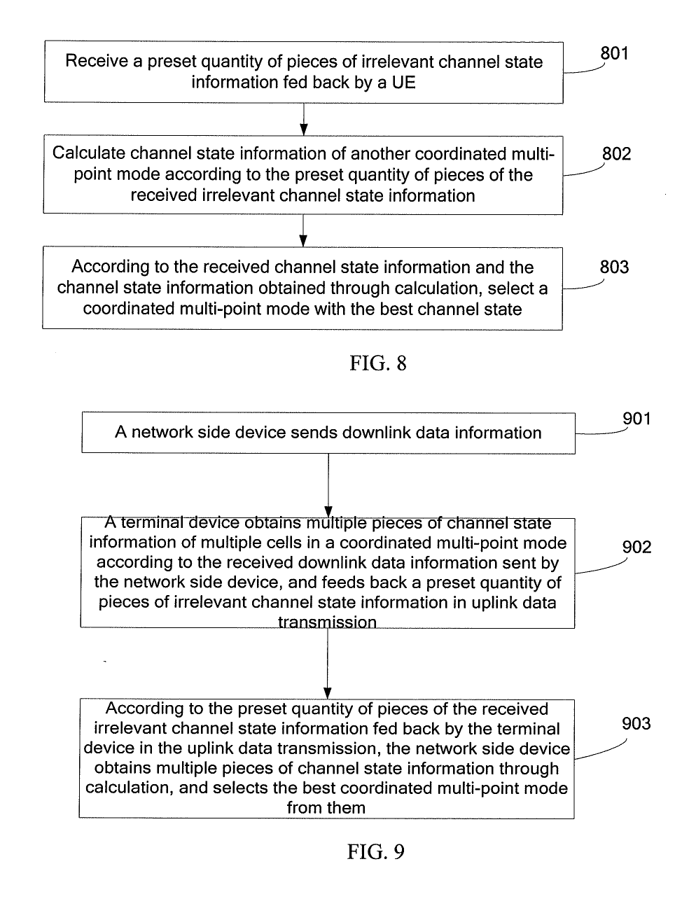

Referring to FIG. 8, this embodiment provides a method for determining a coordinated multi-point mode. A specific process is as follows:

801: Receive the preset quantity of pieces of irrelevant channel state information fed back by a UE.

The preset quantity of the channel state information fed back by the UE may be set according to an actual condition. For example, the preset quantity is set by using the principle of minimizing feedback overhead of multiple pieces of channel state information, or the preset quantity is set according to a coordinated multi-point requirement imposed by a corresponding network side device. This embodiment does not limit the specific preset quantity. An example that 3 pieces of irrelevant channel state information fed back by the UE are received is only taken.

802: Calculate channel state information of another coordinated multi-point mode according to the preset quantity of pieces of the received irrelevant channel state information.

In this step, when the channel state information of another coordinated multi-point mode is calculated according to the preset quantity of pieces of the received irrelevant channel state information, the channel state information of all other coordinated multi-point modes may be calculated according to the preset quantity of pieces of the received irrelevant channel state information; or, according to the preset quantity of pieces of the received irrelevant channel state information, channel state information of a coordinated multi-point mode that forms, together with the preset quantity of pieces of the irrelevant channel state information, a combination of relevant channel state information is calculated.

The following takes an example that 3 pieces of received irrelevant channel state information are SINRs corresponding to TPCC 3, 5, 7 {cell 3, 13, 123} to describe the calculating of the channel state information of another coordinated multi-point mode, which is as shown below:

$$\{ \begin{matrix}{SINR}_{3} = \frac{{‖ {H}_{31} {w}_{3} ‖}_{2}^{2} {P}_{3}}{{‖ {H}_{11} {w}_{1} ‖}_{2}^{2} {P}_{1} + {‖ {H}_{21} {w}_{2} ‖}_{2}^{2} {P}_{2} + {N}_{0} + {I}_{0}} = c \\ {SINR}_{1 , 3} = \frac{{‖ {H}_{11} {w}_{1} ‖}_{2}^{2} {P}_{1} + {‖ {H}_{31} {w}_{3} ‖}_{2}^{2} {P}_{3}}{{‖ {H}_{21} {w}_{2} ‖}_{2}^{2} {P}_{2} + {N}_{0} + {I}_{0}} = e \\ {SINR}_{1 , 2 , 3} = \frac{{‖ {H}_{11} {w}_{1} ‖}_{2}^{2} {P}_{1} + {‖ {H}_{21} {w}_{2} ‖}_{2}^{2} {P}_{2} + {‖ {H}_{31} {w}_{3} ‖}_{2}^{2} {P}_{3}}{{N}_{0} + {I}_{0}} = g\end{matrix} \qquad ( 12 )$$

Specifically, the following linear equation set may be used to calculate the SINRs corresponding to the other four types of TPCCs:

$$\begin{matrix}TPCC 1 \text{:} {SINR}_{1} = \frac{{‖ {H}_{11} {w}_{1} ‖}_{2}^{2} {P}_{1}}{{‖ {H}_{21} {w}_{2} ‖}_{2}^{2} {P}_{2} + {‖ {H}_{31} {w}_{3} ‖}_{2}^{2} {P}_{3} + {N}_{0} + {I}_{0}} = a = \frac{e - c}{ec + 2 c + 1} & ( 13 ) \\ TPCC 2 \text{:} {SINR}_{2} = \frac{{‖ {H}_{21} {w}_{2} ‖}_{2}^{2} {P}_{2}}{{‖ {H}_{11} {w}_{1} ‖}_{2}^{2} {P}_{1} + {‖ {H}_{31} {w}_{3} ‖}_{2}^{2} {P}_{3} + {N}_{0} + {I}_{0}} = b = \frac{g - e}{ge + 2 e + 1} & ( 14 ) \\ TPCC 4 \text{:} {SINR}_{1 , 2} = \frac{{‖ {H}_{11} {w}_{1} ‖}_{2}^{2} {P}_{1} + {‖ {H}_{21} {w}_{2} ‖}_{2}^{2} {P}_{2}}{{‖ {H}_{31} {w}_{3} ‖}_{2}^{2} {P}_{3} + {N}_{0} + {I}_{0}} = d = \frac{g - c}{gc + 2 c + 1} & ( 15 ) \\ TPCC 6 \text{:} {SINR}_{2 , 3} = \frac{{‖ {H}_{21} {w}_{2} ‖}_{2}^{2} {P}_{2} + {‖ {H}_{31} {w}_{3} ‖}_{2}^{2} {P}_{3}}{{‖ {H}_{11} {w}_{1} ‖}_{2}^{2} {P}_{1} + {N}_{0} + {I}_{0}} = f = \frac{ceg + 2 cg + c - e + g}{ce - cg + eg + 2 e + 1} & ( 16 )\end{matrix}$$

Here, only an example that the channel state information of all other coordinated multi-point modes are calculated according to the preset quantity of pieces of the received channel state information is taken. When the UE feeds back the preset quantity of other pieces of irrelevant channel state information, a similar linear equation set may also be used to obtain the channel state information of all other coordinated multi-point modes through calculation, and details are not repeatedly described here.

Optionally, if the UE feeds back only two random types of irrelevant channel state information, an eNB may calculate, according to the two types of received channel state information, channel state information of a coordinated multi-point mode that forms, together with the two types of channel state information, a combination of relevant channel state information. Taking TPCC 3, 4, 7 {cell 3, cells 1 and 2, cells 1, 2 and 3} as an example, analysis is as follows:

$$\{ \begin{matrix}{SINR}_{3} = \frac{{SINR}_{1 , 2 , 3} - {SINR}_{1 , 2}}{{SINR}_{1 , 2 , 3} {SINR}_{1 , 2} + 2 {SINR}_{1 , 2} + 1} \\ {SINR}_{1 , 2} = \frac{{SINR}_{1 , 2 , 3} - {SINR}_{3}}{{SINR}_{1 , 2 , 3} {SINR}_{3} + 2 {SINR}_{3} + 1} \\ {SINR}_{1 , 2 , 3} = \frac{2 {SINR}_{1 , 2} {SINR}_{3} + {SINR}_{1 , 2} + {SINR}_{3}}{1 - {SINR}_{1 , 2} {SINR}_{3}}\end{matrix} \qquad ( 17 )$$

It may be learned from the foregoing analysis that, the UE feeds back two of SINR₃, SINR_{1,2}, and SINR_{1, 2, 3}, that is, another value may be obtained through (17).

It should be noted that, this step is also applicable to the scenario that there are only 2 coordinating cells. In this case, an SINR of a third type of TPCC may be obtained according to 2 types of TPCCs that are randomly reported, and analysis is as follows:

$$\{ \begin{matrix}{SINR}_{1} = \frac{{‖ {H}_{11} {w}_{1} ‖}_{2}^{2} {P}_{1}}{{‖ {H}_{21} {w}_{2} ‖}_{2}^{2} {P}_{2} + {N}_{0} + {I}_{0}} = l \\ {SINR}_{2} = \frac{{‖ {H}_{11} {w}_{1} ‖}_{2}^{2} {P}_{2}}{{‖ {H}_{21} {w}_{2} ‖}_{2}^{2} {P}_{1} + {N}_{0} + {I}_{0}} = m \\ {SINR}_{1 , 2}^{H} \frac{{{‖ }_{11} {w}_{1} ‖}_{2}^{2} {P}_{1} + {‖ {H}_{21} {w}_{2} ‖}_{2}^{2} {P}_{2}}{{N}_{0} + {I}_{0}} = n\end{matrix} \qquad ( 18 )$$

Solve the linear equation set (18) to obtain:

$$\{ \begin{matrix}l = \frac{n - m}{n m + 2 m + 1} \\ m = \frac{n - l}{nl + 2 l + 1} \\ n = \frac{2 l m + l + m}{1 - l m}\end{matrix} \qquad ( 19 )$$

It may be learned from the foregoing analysis that, according to two of SINR₁, SINR₂ and SINR_{1,2}, a third one may be obtained.

In a practical application, a preset table may be queried to work out the other channel state information. The correspondence between the multiple pieces of irrelevant channel state information and the other channel state information may be preset in the table, which is not limited in this embodiment.

803: According to the received channel state information and the channel state information that is obtained through calculation, select a coordinated multi-point mode with the best channel state.

It should be noted that, in this embodiment, an example that the channel state information fed back by the UE is an SINR is only taken for describing the method provided in the embodiment. In view of this feedback form, the network side device may obtain a CQI value according to the correspondence between the SINR and the CQI involved in the second embodiment, and then select a best coordinated multi-point mode according to the CQI value, and determine that downlink data information is transmitted in a modulation coding scheme (MCS) corresponding to the best coordinated multi-point mode. This embodiment does not limit the correspondence between the CQI and the MCS. Reference may be made to Table 6:

TABLE 6

| CQI | | Code | |
|---|---|---|---|
| index | modulation | Rate × 1024 | efficiency |
| 0 | Out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

In summary, with the method provided in this embodiment, the other channel state information is calculated according to the preset quantity of pieces of the received irrelevant channel state information, so that a best coordinated multi-point mode may be selected, thereby ensuring communication quality.

### Embodiment 5

Referring to FIG. 9, this embodiment provides a communication method. A process of the method is specifically as follows:

901: A network side device sends downlink data information.

902: A terminal device obtains multiple pieces of channel state information of multiple cells in a coordinated multi-point mode according to the received downlink data information sent by the network side device, and feeds back the preset quantity of pieces of irrelevant channel state information in uplink data transmission.

903: According to the preset quantity of pieces of the received irrelevant channel state information fed back by the terminal device in the uplink data transmission, the network side device obtains multiple pieces of channel state information through calculation, and selects a best coordinated multi-point mode from them.

In summary, with the method provided in this embodiment, the terminal device selects the preset quantity of pieces of irrelevant channel state information from multiple pieces of channel state information, and feeds back the irrelevant channel state information to the network side device, so that the network side device can calculate multiple pieces of channel state information according to the received channel state information, and further select a coordinated multi-point mode with the best channel state from more channel state information, thereby ensuring quality of transmitting downlink data information.

### Embodiment 6

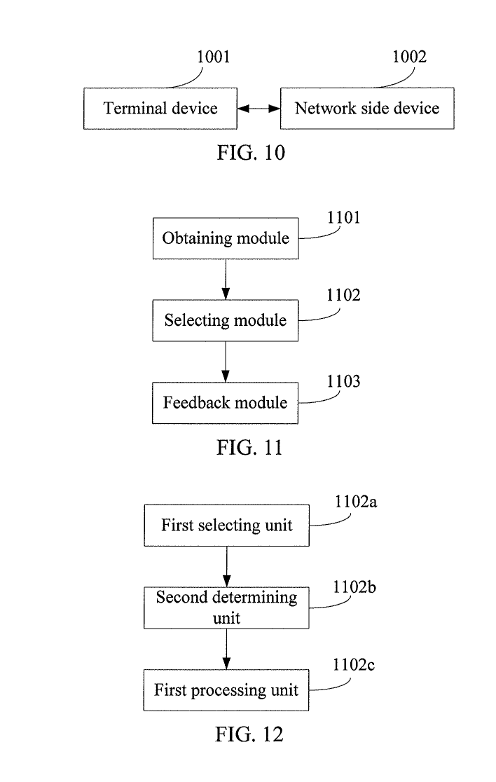

Referring to FIG. 10, this embodiment provides a communication system. The communication system includes: a terminal device 1001 and a network side device 1002, where the network side device 1002 is a network side device corresponding to the terminal device 1001.

The terminal device 1001 is configured to: obtain multiple pieces of channel state information of multiple cells in a coordinated multi-point mode; select the preset quantity of pieces of irrelevant channel state information from the multiple pieces of channel state information, and feed back the selected channel state information to the corresponding network side device 1002.

The network side device 1002 is configured to: receive the preset quantity of pieces of irrelevant channel state information fed back by the terminal device 1001; calculate channel state information of another coordinated multi-point mode according to the preset quantity of pieces of the received irrelevant channel state information; and select a coordinated multi-point mode with the best channel state from the received channel state information and the channel state information that is obtained through calculation.

Specifically, when selecting the preset quantity of pieces of irrelevant channel state information from the multiple pieces of channel state information, the terminal device 1001 is specifically configured to: select the preset quantity of pieces of channel state information from the multiple pieces of channel state information, and determine whether the preset quantity of pieces of the selected channel state information are relevant; if they are relevant, continue the selecting until the preset quantity of pieces of irrelevant channel state information are selected.

Alternatively, the terminal device 1001 is specifically configured to: group multiple pieces of channel state information according to the preset quantity to obtain multiple combinations each of which includes the preset quantity of pieces of channel state information; determine irrelevant combinations from the multiple combinations each of which includes the preset quantity of pieces of channel state information, and select a combination of channel state information from the determined irrelevant combinations.

Alternatively, the terminal device 1001 is specifically configured to: sort the multiple pieces of channel state information into types according to the number of cells that provide services; select a piece of channel state information in each type to obtain the preset quantity of pieces of channel state information; determine whether the preset quantity of pieces of the obtained channel state information are relevant; if they are relevant, continue the selecting until the preset quantity of pieces of irrelevant channel state information are selected.

Alternatively, the terminal device 1001 is specifically configured to: sort the multiple pieces of channel state information into types according to the number of cells that provide services; select a piece of channel state information from each type each time to obtain multiple combinations each of which includes the preset quantity of pieces of channel state information; determine irrelevant combinations from the multiple combinations each of which includes the preset quantity of pieces of channel state information; and select a combination of channel state information from the irrelevant combinations.

When feeding back the selected channel state information to the corresponding network side device 1002, the terminal device 1001 is specifically configured to: feed back the preset quantity of pieces of the selected irrelevant channel state information to the corresponding network side device 1002 according to a preset order; or feed back the preset quantity of pieces of the selected irrelevant channel state information and a number of the corresponding coordinated multi-point mode to the corresponding network side device 1002.

When calculating the channel state information of another coordinated multi-point mode according to the preset quantity of pieces of the received irrelevant channel state information, the network side device 1002 is specifically configured to calculate multiple pieces of channel state information of the other coordinated multi-point modes according to the preset quantity of pieces of the received irrelevant channel state information; or according to the preset quantity of pieces of the received irrelevant channel state information, calculate channel state information that forms, together with the preset quantity of pieces of irrelevant channel state information, a combination of relevant channel state information.

In summary, in the communication system provided in this embodiment, the terminal device selects the preset quantity of pieces of irrelevant channel state information from multiple pieces of channel state information, and feeds back the irrelevant channel state information to the corresponding network side device, so that the network side device can calculate the other channel state information according to the received channel state information, and further select a coordinated multi-point mode with the best channel state from more channel state information, and determine a more accurate modulation coding scheme, thereby ensuring quality of transmitting downlink data information.

### Embodiment 7

Referring to FIG. 11, this embodiment provides a terminal device. The terminal device includes:

an obtaining module 1101, configured to obtain multiple pieces of channel state information of multiple cells in a coordinated multi-point mode;

a selecting module 1102, configured to select the preset quantity of pieces of irrelevant channel state information from the multiple pieces of channel state information obtained by the obtaining module 1101; and

a feedback module 1103, configured to feed back the channel state information selected by the selecting module 1102 to a corresponding network side device.

Specifically, referring to FIG. 12, the selecting module 1102 specifically includes:

a first selecting unit 1102a, configured to select the preset quantity of pieces of channel state information from the multiple pieces of channel state information;

a first determining unit 1102b, configured to determine whether the preset quantity of pieces of channel state information selected by the first selecting unit 1102a are relevant; and

a first processing unit 1102c, configured to: when the first determining unit 1102b determines that the preset quantity of pieces of the selected channel state information are relevant, enable the first selecting unit 1102a to continue the selecting until the preset quantity of pieces of irrelevant channel state information are selected.

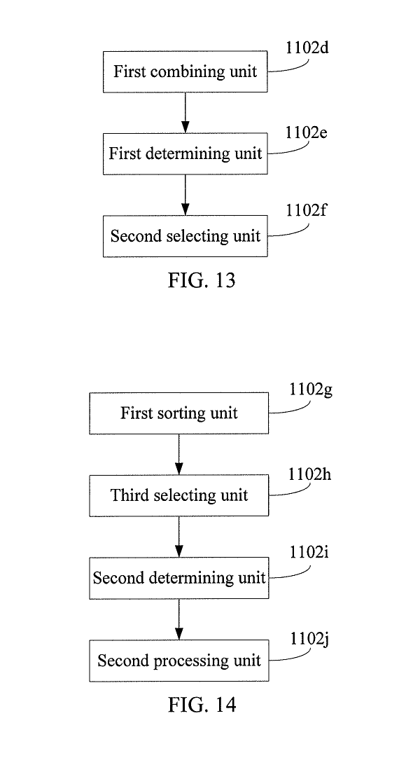

Optionally, referring to FIG. 13, the selecting module 1102 specifically includes:

a first combining unit 1102d, configured to group the multiple pieces of channel state information according to the preset quantity to obtain multiple combinations each of which includes the preset quantity of pieces of channel state information;

a first determining unit 1102e, configured to determine irrelevant combinations from the multiple combinations each of which includes the preset quantity of pieces of channel state information and are obtained by the first combining unit 1102d; and

a second selecting unit 1102f, configured to select a combination of channel state information from the irrelevant combinations determined by the first determining unit 1102e.

Optionally, referring to FIG. 14, the selecting module 1102 specifically includes:

a first sorting unit 1102g, configured to sort the multiple pieces of channel state information into types according to the number of cells that provide services;

a third selecting unit 1102h, configured to select a piece of channel state information in each type obtained after the sorting performed by the first sorting unit 1102g, and obtain the preset quantity of pieces of channel state information;

a second determining unit 1102i, configured to determine whet her the preset quantity of pieces of channel state information obtained by the third selecting unit 1102h through selection are relevant; and

a second processing unit 1102j, configured to: when the second determining unit 1102i determines that the preset quantity of pieces of the obtained channel state information are relevant, enable the third selecting unit 1102h to continue the selecting until the preset quantity of pieces of irrelevant channel state information are selected.

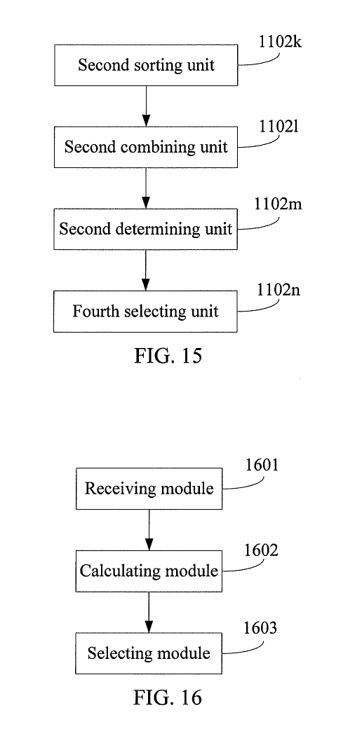

Optionally, referring to FIG. 15, the selecting module 1102 specifically includes:

a second sorting unit 1102k, configured to sort the multiple pieces of channel state information into types according to the number of cells that provide services;

a second combing unit 1102l, configured to each time randomly select a piece of channel state information from each type obtained by the second sorting unit 1102k, and obtain multiple combinations each of which includes the preset quantity of pieces of channel state information;

a second determining unit 1102m, configured to determine irrelevant combinations from the multiple combinations each of which includes the preset quantity of pieces of channel state information and are obtained by the second combining unit 1102l; and

a fourth selecting unit 1102n, configured to select a combination of channel state information from the irrelevant combinations determined by the second determining unit 1102m.

The feedback module 1103 is specifically configured to: feed back the preset quantity of pieces of irrelevant channel state information selected by the selecting module 1102 to the corresponding network side device according to a preset order; or feed back the preset quantity of pieces of irrelevant channel state information selected by the selecting module 1102 and a number of the corresponding coordinated multi-point mode to the corresponding network side device.

In a practical application, the terminal device may be a user equipment, and may be specifically a terminal device, such as a mobile station, a notebook computer, or a PDA (Personal Digital Assistant, personal digital assistant), which are not limited in this embodiment.

The terminal device provided in this embodiment selects the preset quantity of pieces of irrelevant channel state information from multiple pieces of channel state information, and feeds back the irrelevant channel state information to the corresponding network side device, so that the network side device can calculate the other channel state information according to the received channel state information, and further select a coordinated multi-point mode with the best channel state from more channel state information, and determine a more accurate modulation coding scheme, thereby ensuring quality of transmitting downlink data information.

### Embodiment 8

Referring to FIG. 16, this embodiment provides a network side device. The network side device includes:

a receiving module 1601, configured to receive the preset quantity of pieces of irrelevant channel state information fed back by a terminal device;

a calculating module 1602, configured to calculate channel state information corresponding to another coordinated multi-point mode according to the preset quantity of pieces of irrelevant channel state information received by the receiving module 1601; and

a selecting module 1603, configured to: select a coordinated multi-point mode with the best channel state from the channel state information received by the receiving module 1601 and the channel state information that is obtained through calculation by the calculating module 1202.

The calculating module 1602 is specifically configured to: calculate multiple pieces of channel state information of the other coordinated multi-point modes according to the preset quantity of pieces of irrelevant channel state information received by the receiving module 1601; or according to the preset quantity of pieces of irrelevant channel state information received by the receiving module 1601, calculate channel state information of a coordinated multi-point mode that forms, together with the preset quantity of pieces of irrelevant channel state information, a combination of relevant channel state information.

In a practical application, the network side device may be a base station, and may be specifically a BS (Base Station, base station), a NodeB (NodeB, NodeB), an eNodeB (E-UTRAN NodeB, E-UTRAN NodeB), a HeNodeB (Home E-UTRAN NodeB, home E-UTRAN NodeB), a relay station, a relay node, or the like, which is not limited in this embodiment.

In summary, the network side device provided in this embodiment receives the irrelevant channel state information fed back by the terminal device, calculates the other channel state information according to the received channel state information, and further selects a coordinated multi-point mode with the best channel state from more channel state information, thereby ensuring quality of transmitting downlink data information.

The foregoing sequence numbers of the embodiments of the present invention are merely for ease of description, and do not represent the preference order of the embodiments.

Persons of ordinary skill in the art may understand that all or part of the processes of the method in the foregoing embodiments may be implemented by a computer program instructing relevant hardware. The program may be stored in a computer readable storage medium. When the program is executed, the steps of the processes of the method in the foregoing embodiments may be included. The storage medium may be a magnetic disk, a compact disk, a read-only memory (Read-Only Memory, ROM), a random access memory (Random Access Memory, RAM), or the like.

The foregoing descriptions are merely about several embodiments of the present invention. Those skilled in the art may make various modifications or variations to the present invention according to the disclosure of the application without departing from the idea and scope of the present invention. Persons of ordinary skill in the art may understand that the embodiments or the features of the embodiments may be combined with each other to form a new embodiment in the case of no conflict.

1. A method for feeding back channel state information, comprising:
obtaining multiple pieces of channel state information of multiple cells in a coordinated multi-point mode, wherein each piece of channel state information corresponds to one type of coordinated multi-point transmission point configuration; and
selecting a preset quantity of pieces of irrelevant channel state information from the multiple pieces of the channel state information; and
feeding back the selected channel state information to a network side device.

2. The method according to claim 1, wherein:
the selecting the preset quantity of pieces of the irrelevant channel state information from the multiple pieces of the channel state information comprises:
selecting the preset quantity of pieces of channel state information from the multiple pieces of the channel state information, and determining whether the selected preset quantity of pieces of the channel state information are relevant; and if the selected preset quantity of pieces of the channel state information are relevant, continuing the selecting until the preset quantity of pieces of the irrelevant channel state information are selected.

3. The method according to claim 1, wherein:
the selecting the preset quantity of pieces of the irrelevant channel state information from the multiple pieces of the channel state information comprises:
grouping the multiple pieces of the channel state information according to the preset quantity to obtain multiple combinations each of which comprises the preset quantity of pieces of channel state information; determining irrelevant combinations from the multiple combinations each of which comprises the preset quantity of pieces of channel state information, and selecting a combination of channel state information from the determined irrelevant combinations.

4. The method according to claim 2, wherein:
the selecting the preset quantity of pieces of the channel state information from the multiple pieces of the channel state information comprises:
sorting the multiple pieces of the channel state information into types according to the number of cells that provide services, and selecting a piece of channel state information in each type to obtain the preset quantity of pieces of the channel state information.

5. The method according to claim 3, wherein:
the grouping the multiple pieces of the channel state information according to the preset quantity to obtain the multiple combinations each of which comprises the preset quantity of pieces of the channel state information comprises:
sorting the multiple pieces of the channel state information into types according to the number of cells that provide services; selecting a piece of channel state information from each type each time to obtain a combination that comprises the preset quantity of pieces of the channel state information; and obtaining the multiple combinations each of which comprises the preset quantity of pieces of the channel state information after performing the selection several times.

6. The method according to claim 1, wherein:
the selecting the preset quantity of pieces of the irrelevant channel state information from the multiple pieces of the channel state information comprises:
selecting the preset quantity of pieces of the irrelevant channel state information from the multiple pieces of the channel state information by searching a preset table.

7. The method according to claim 1, wherein:
the feeding back the selected channel state information to the network side device comprises one of:
feeding back the selected channel state information to the network side device according to a preset order; or
feeding back the selected channel state information and a number of a coordinated multi-point mode corresponding to the selected channel state information to the network side device.

8. A method for determining a coordinated multi-point mode, comprising:
receiving a preset quantity of pieces of irrelevant channel state information fed back by a terminal device, wherein each piece of channel state information corresponds to one type of coordinated multi-point transmission point configuration;
calculating channel state in formation corresponding to other coordinated multi-point transmission point configuration according to the preset quantity of pieces of the irrelevant channel state information; and
according to the preset quantity of pieces of the irrelevant channel state information and the channel state information that is obtained through calculation, selecting a coordinated multi-point mode with a best channel state.

9. A terminal device, comprising:
an obtaining module, configured to obtain multiple pieces of channel state information of multiple cells in a coordinated multi-point mode, wherein each piece of channel state information corresponds to one type of coordinated multi-point transmission point configuration; and
a selecting module, configured to select a preset quantity of pieces of irrelevant channel state information from the multiple pieces of the channel state information obtained by the obtaining module; and
a feedback module, configured to feed back the channel state information selected by the selecting module to a network side device.

10. The device according to claim 9, wherein the selecting module comprises:
a first selecting unit, configured to select the preset quantity of pieces of channel state information from the multiple pieces of the channel state information;
a first determining unit, configured to determine whether the selected preset quantity of pieces of the channel state information selected by the first selecting unit are relevant; and
a first processing unit, configured to: when the first determining unit determines that the selected preset quantity of pieces of the selected channel state information are relevant, instruct the first selecting unit to continue the selecting until the first selecting unit selects the preset quantity of pieces of the irrelevant channel state information.

11. The device according to claim 9, wherein the selecting module comprises:
a first combining unit, configured to group the multiple pieces of the channel state information according to the preset quantity to obtain multiple combinations each of which comprises the preset quantity of pieces of channel state information;
a first determining unit, configured to determine irrelevant combinations from the multiple combinations each of which comprises the preset quantity of pieces of the channel state information and are obtained by the first combining unit; and
a second selecting unit, configured to select a combination of channel state information from the irrelevant combinations determined by the first determining unit.

12. The device according to claim 9, wherein:
the feedback module is configured to: feed back the channel state information selected by the selecting module to the network side device according to a preset order; or feed back the channel state information selected by the selecting module and a number of a coordinated multi-point mode corresponding to the selected channel state information to the network side device.

13. A network side device, comprising:
a receiving module, configured to receive a preset quantity of pieces of irrelevant channel state information fed back by a terminal device, wherein each piece of channel state information corresponds to one type of coordinated multi-point transmission point configuration;
a calculating module, configured to calculate channel state information corresponding to other coordinated multi-point transmission point configuration according to the preset quantity of pieces of the irrelevant channel state information received by the receiving module; and
a selecting module, configured to: according to the preset quantity of pieces of the irrelevant channel state information and the channel state information that is obtained through calculation by the calculating module, select a coordinated multi-point mode with a best channel state.
